(19) United States
(12) Patent Application Publication
(10) Pub. No.: US 2004/0230570 A1
(43) Pub. Date: Nov. 18, 2004

(54) Search processing method and apparatus

(75) Inventors: Hiroyuki Hatta, Kawasaki (JP); Nobuyuki Hiratsuka, Kawasaki (JP); Isamu Watanabe, Kawasaki (JP); Kazunari Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/766,039

(22) Filed: Jan. 29, 2004

(30) Foreign Application Priority Data
Mar. 20, 2003 (JP) 2003-077724

(51) Int. Cl. G06F 17/30

(52) U.S. Cl. 707/3

(57) ABSTRACT

This invention enables a searcher to analyze search results, intuitively. Data items of plural documents extracted by the search are presented as the following processing keys and selectable display items to a user in a first display form, and in response to the user's selection of the display item, data items of the documents corresponding to the selected display item are further presented to the user as the further following processing keys and selectable display items in a second display form designated by the user. Therefore, the analysis object and display manner are changed with an intuitive interface to progress the analysis.

### TECHNICAL FIELD OF THE INVENTION

This invention relates to search technology for a document database, and more particularly to a user interface when the search is carried out.

### BACKGROUND OF THE INVENTION

Hitherto, when features, similarities or the like of sentences included in a document group were analyzed, for example, the document group was processed by using the text mining technology, search technology with weighting calculation, or the like, and the processing result was converted into a table or a graph to present it to an analyst. In the conventional technology, the table, graph or diagram was individually generated and displayed based on the original data in the document group.

However, there is a case in which the analyst would like to obtain the following analysis result from a certain analysis result when progressing the analysis. It was possible for the conventional technology to carry out a simple processing such as simply referring to a portion of the search result, and narrowing the search result, but a pertinent portion was merely displayed and any changes were not given to the meanings of the search results. Furthermore, when only an interesting portion in a certain table is displayed with a new viewpoint or the portion is converted into a diagram or the like in another viewpoint to display it, for instance, the following process was needed: that is, 1) return to the original data in the document group once, 2) set a search condition again, 3) carry out a processing by using numerical values, text, or the like in the data of the document group, and 4) convert the processing result into a desired display form. Therefore, in such a case, because it took much time and work, the analyst had to be confronted with a big hurdle when he or she would like to make a consideration for the following analysis from the analysis result at once.

In addition, JP-A-2001-92851 discloses following technology. That is, a method is disclosed in which after data of a search file obtained from a patent/technology document search system is automatically converted by a computer into patent information or technology information analysis master table, a patent map or various aggregation graph in a necessary form is output. However, even by this technology, in a case where the data of the search file must be changed, it must be separately converted into another master table. Therefore, in a case where the previous search result is narrowed, it is necessary to prepare new search file as usual, and any processing and work are not simplified.

### SUMMARY OF THE INVENTION

Therefore, an object of this invention is to provide the search processing technology to enable a searcher to intuitively analyze the search result.

A search processing method according to this invention comprises the steps of: searching a predetermined document group according to a search condition specified by a user, and storing data of a plurality of documents extracted by the search into a storage device; transforming the data of the plurality of documents extracted by the search into data to indicate the data of the plurality of documents to the user in a first display form and to enable the user to select each display item as a following processing key, and outputting the transformed data; extracting data of documents corresponding to the display items directly or indirectly selected by the user; and transforming the data of the documents corresponding to the selected display items into data to indicate the data of the documents to the user in a second display form specified by the user and to enable the user to select each display item as a following processing key, and outputting the transformed data.

Thus, the data of the plural documents extracted by the search is indicated as following processing keys and selectable display items to the user in the first display form, and in response to the selection of display items by the user, the data of the documents corresponding to the selected display items is indicated as further following processing keys and selectable display items to the user in the second display form specified by the user. Therefore, it becomes possible to change the analysis object and display manner via the intuitive interface and to progress the analysis.

Moreover, each of the aforementioned first and second display forms may be at least either of (a) a form indicating the plurality of documents to be processed that are clustered by used words, by a predefined display matter, (b) a form indicating the plurality of documents to be processed, by a predefined display matter and a connection line representing a degree of relevancy between the plurality of documents, that is calculated by used words, (c) a form indicating a result in which the plurality of documents to be processed are classified and aggregated as to used words, by a graph, (d) a form indicating used words in the plurality of documents to be processed and a connection line representing a degree of relevancy among the used words, (e) a form indicating a document group associated by a specific matter among the plurality of documents to be processed, by the specific item, and a degree of relevancy between the document group associated by the specific item and each used word in the plurality of documents to be processed, by a connection line between the specific matter and each used word. For example, the transition among these display forms is freely carried out, and the analysis can be progressed. Incidentally, this invention is not limited to these display forms, and other display forms may be included. Moreover, an arbitrary display form may be selected in another combination.

In addition, in the aforementioned first and second transforming steps, a display program corresponding to the display form may be designated and data for the display program may be generated. The display program is switched in conformity with the environment of the user terminal as the occasion demands. Moreover, this invention can be realized in any of the stand-alone environment and client-server environment.

Incidentally, the aforementioned method may be carried out by a combination of a program and computer hardware, and the computer works as a search processing apparatus. In addition, the aforementioned program is stored in a storage medium or storage device such as a flexible disk, CD-ROM, magneto-optical disk, semiconductor memory, and hard disk. Moreover, it may be distributed via a network as a digital signal. Incidentally, an intermediate processing result is temporarily stored into a storage device such as a main memory.

### BRIEF DESCRIPTION OF THE DRAWINGS

FIG. 1 is a functional block diagram in one embodiment of this invention;

FIG. 2 is a drawing showing a main processing flow in the embodiment of this invention;

FIG. 3 is a drawing showing one example of the data stored in a document DB;

FIG. 4 is a drawing showing one example of data stored in a related word data storage;

FIG. 5 is a drawing showing a screen example presenting a first search result;

FIG. 6 is a drawing showing a processing flow to display a first display form;

FIG. 7 is a drawing showing the first display form;

FIG. 8 is a drawing showing one example of a display form designation column in the first display form;

FIG. 9 is a drawing showing the first display form;

FIG. 10 is a drawing showing a menu in the first display form;

FIG. 11 is a drawing showing a main processing flow in the embodiment of this invention;

FIG. 12 is a drawing showing a processing flow to display a second display form;

FIG. 13 is a drawing showing one example of data stored in a relevancy degree data storage;

FIG. 14 is a drawing showing the second display form;

FIG. 15 is a drawing showing a third display form;

FIG. 16 is a drawing showing the second display form;

FIG. 17 is a drawing showing a fourth display form;

FIG. 18 is a drawing showing a processing flow to display a fifth display form;

FIG. 19 is a drawing showing the fifth display form;

FIG. 20 is a drawing showing a sixth display form;

FIG. 21 is a drawing showing the fifth display form;

FIG. 22 is a drawing showing a menu in the fifth display form;

FIG. 23 is a drawing showing a processing flow to display a seventh display form;

FIG. 24 is a drawing showing the seventh display form;

FIG. 25 is a drawing showing a processing flow to display an eighth display form; and

FIG. 26 is a drawing showing the eighth display form.

### DETAILED DESCRIPTION OF THE PREFERRED EMBODIMENTS

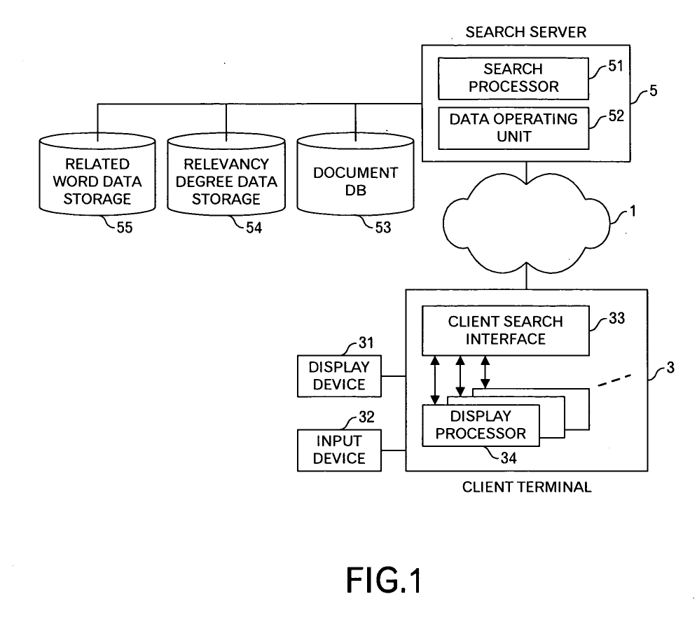

FIG. 1 shows a system outline figure according to one embodiment of the present invention. For instance, a search server 5 that has a web server function, for example, and one or a plurality of client terminals 3 that are personal computers and have a web browser function are connected with a network 1 that is the Internet or Local Area Network (LAN), for example.

The search server 5 manages a document DB 53 that stores documents to be searched, relevancy degree data storage 54 that stores data or the like concerning the degree of relevancy between documents extracted by the search or the like, and related word data storage 55 that stores data of used words or phrases (hereafter, simply called “words”) in the documents extracted by the search or the like. Moreover, the search server 5 includes a search processor 51 that carries out a search processing to the document DB 53, and data operating unit 52 that processes data or the like of the documents extracted by the search processor 51 by a predetermined algorithm. Incidentally, the search server 5 may achieve the functions explained below by not only one computer but also plural computers. Moreover, the search server 5 may communicate with the client terminals 3 via an interface other than the web server function by conforming itself with the function of the client terminals 3.

Input devices 32 such as a mouse and keyboard, and a display device 31 such as a display or the like are connected to the client terminal 3, and the client terminal 3 communicates data with the search servers 5, and has a client search interface 33 that provides a user interface to the user of the client terminal 3, and one or a plurality of display processors 34 that carry out a display processing when a table, graph, flow diagram of the search result, or the like is displayed and provide an user interface for the table, graph, flow diagram or the like. When the data is communicated with the search servers 5 based on the web technology, the client search interface 33 is a web browser. However, it is also possible to use a dedicated client program.

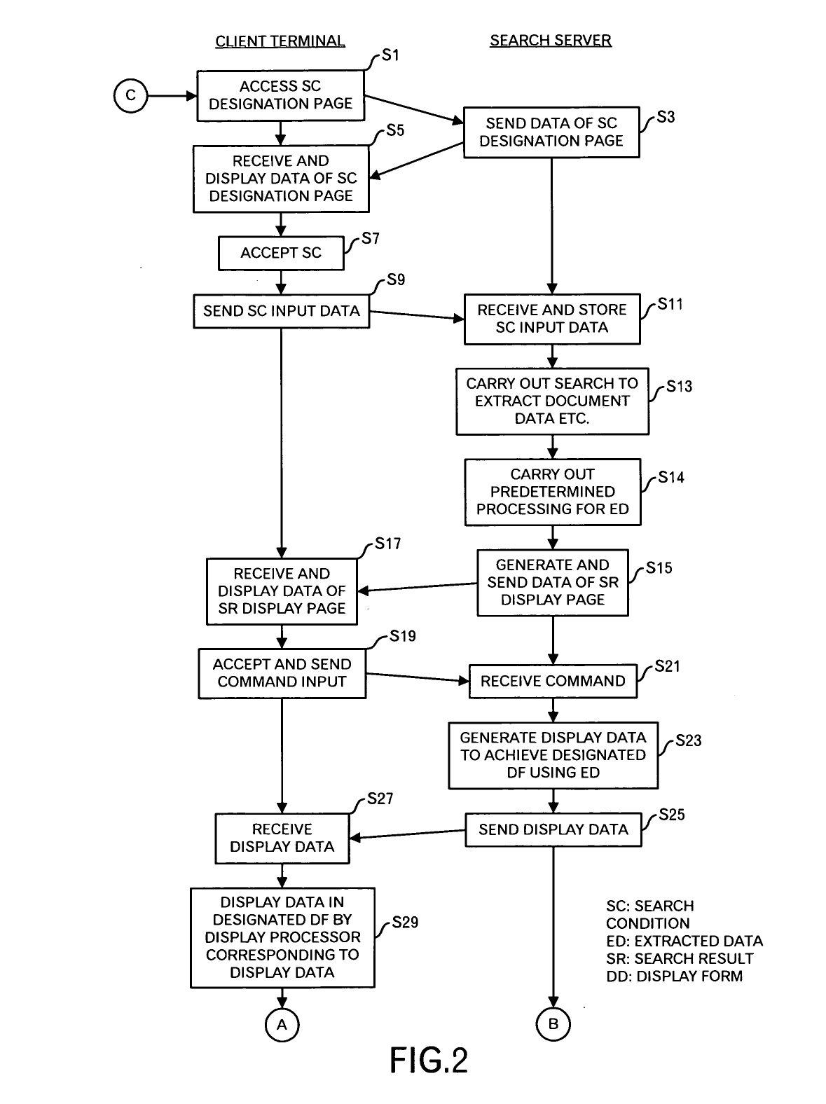

Next, the processing content in the system shown in FIG. 1 will be explained by using FIG. 2 to FIG. 26. Incidentally, the search of the patent documents will be explained as an example in the following descriptions. First of all, a user operates the input device 32 of the client terminal 3 to give an instruction to the client search interface 33, and causes it access a search condition designation page (step S1). The search server 5 transmits the data of the search condition designation page to the client terminal 3 in response to the access by the client terminal 3 (step S3). The client search interface 33 of the client terminal 3 receives the data of the search condition designation page from the search server 5, and displays it on the display device 31 (step S5). For instance, a screen including at least a keyword input column, a column for specifying the database(s) to be searched, and the like is displayed. According to circumstances, sentences may be input instead of the keywords to use them as a search condition. In this case, the search words are extracted from the sentences by the morphemic analysis or the like. The user inputs the search keyword and the like, and specifies the database(s) to be searched.

The client search interface 33 of the client terminal 3 accepts the search condition input such as the search keyword from the user (step S7), and transmits the search condition input data to the search server 5 (step S9). The search processor 51 of the search server 5 receives the search condition input data from the client terminal 3, and temporarily stores it into the storage device (step S11). Then, it searches the document DB 53 according to the search condition such as the search keyword, and extracts the data of the pertinent documents (step S13).

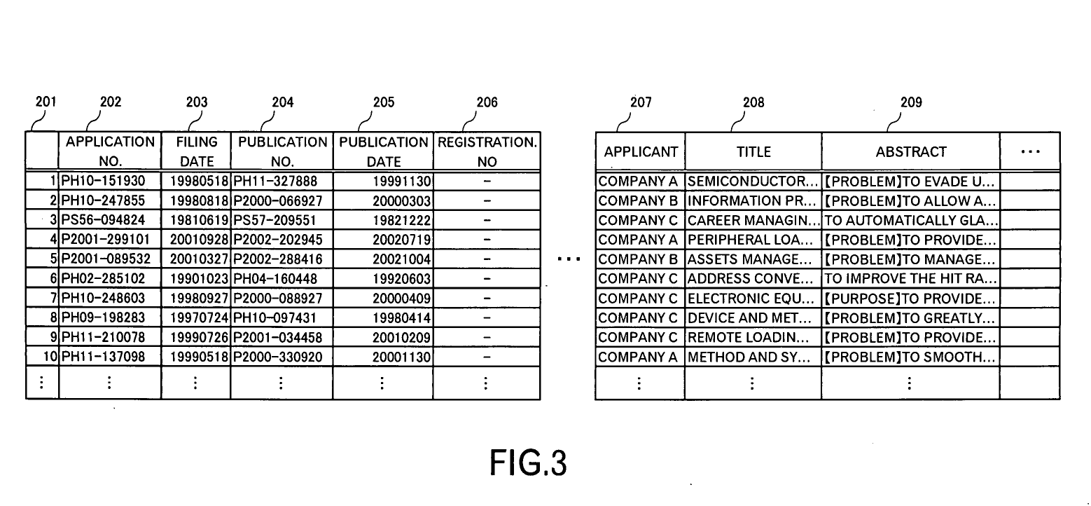

Data as shown in FIG. 3 is stored in the document DB 53, for example. A table example in FIG. 3 includes a column 201 of a record number of a document, column 202 of an application number, column 203 of a filing date, column 204 of a publication number, column 205 of a publication date, column 206 of a registration number, . . . column 207 of an applicant, column 208 of a title, column 209 of an abstract, and the like. In addition to the aforementioned data, data of the text is stored. Referring to such data, the search is carried out.

Then, the data operating unit 52 carries out a predetermined processing for the extracted data (step S14). The predetermined processing is a processing in which a degree of relevancy of each extracted document is calculated for the search keyword or the like, for example, and the extracted documents are rearranged according to the degrees of relevancy. In addition, it is a processing in which the degrees of relevancy between the extracted document and words being used are calculated, and the extracted documents are arranged in descending order of the degree of relevancy. Incidentally, the processing in which the degree of relevancy is calculated to arrange according to the degree of relevancy is the same as in the conventional art, and a method is well-known in which words in the document are weighted using “TFIDF” and/or “information volume of Kullback”, and then, the document is represented as a vector by using the weights of the words, and the degree of relevancy of the document is calculated by the scalar product. Moreover, JP-A-2000-315207 and JP-A-2002-245061 also disclose the same kinds of methods, for instance. These processing results are held in a work memory area in the search server 5.

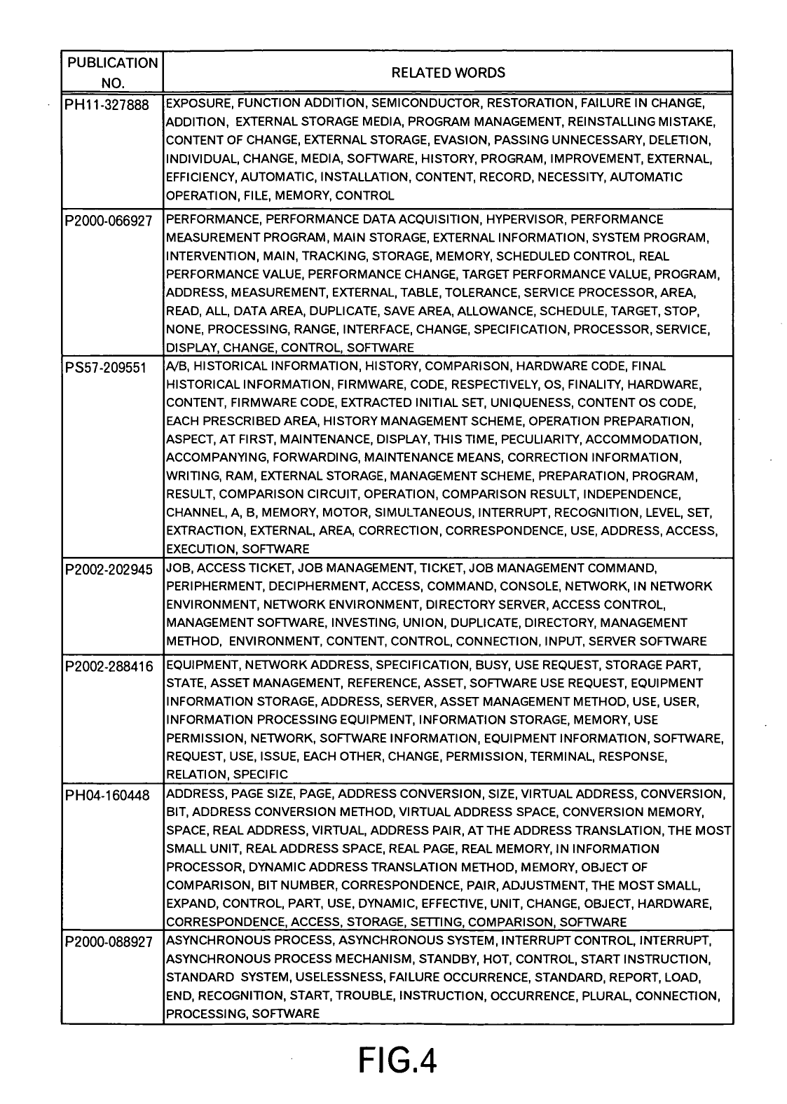

Incidentally, as for words used in each document, words that have a high degree of relevancy may be specified as related words in advance, and they may be registered into the related word data storage 55 to use them for the aforementioned processing. For instance, data as shown in FIG. 4 is registered in the related word data storage 55. In an example of FIG. 4, related words are enumerated so as to correspond to the publication number.

Then, the search server 5 generates data of a search result display page including the processing result at the step S14, and transmits it to the client terminal 3 (step S15). The client search interface 33 in the client terminal 3 receives the data of the search result display page from the search server 5, and displays it on the display device (step S17).

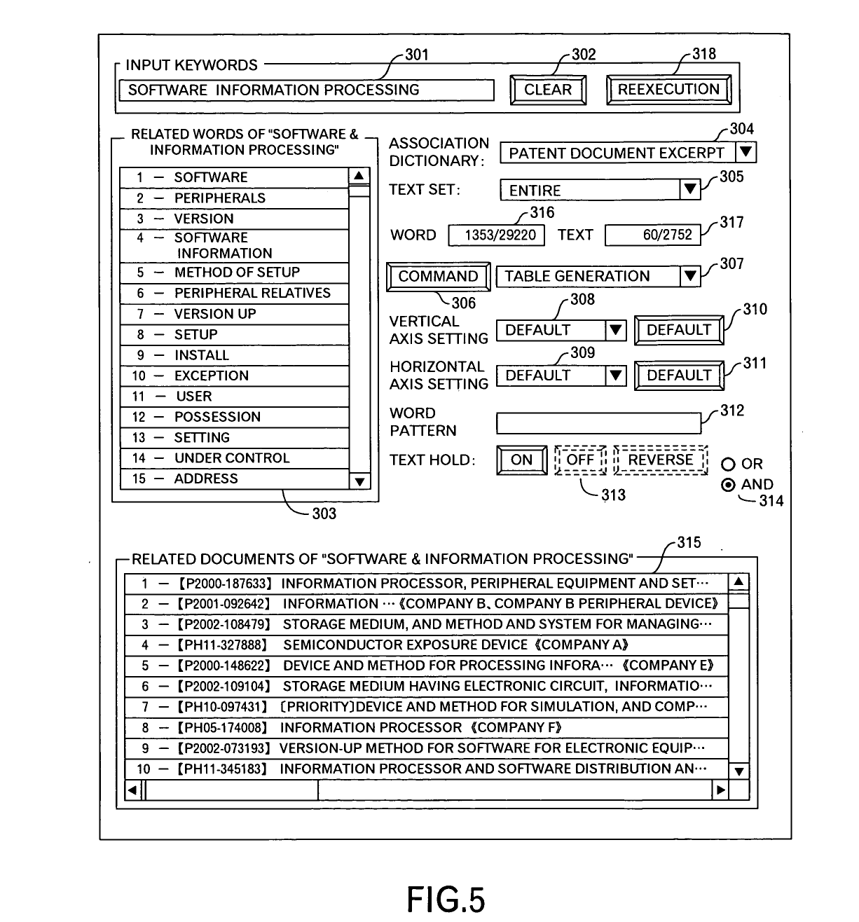

For instance, a screen as shown in FIG. 5 is displayed on the display device 31. In an example of FIG. 5, the screen includes a keyword input column 301, clear button 302, search re-execution button 318, related word display column 303 to display words deeply related to the input keyword in order of rankings, association dictionary designation column 304 to specify database (s) that stores documents to be searched, text set designation column 305 to specify the entire or subset of the database (s) specified in the association dictionary designation column 304, word display column 316 to display (the number of related words in the document group in which the input keyword occurs/ the number of related words in all of the document groups), text display column 317 to display (the number of documents in which the input keyword occurs/ the total number of documents), command designation column 307 to select a display form such as a table generation, graph generation, flow generation, or the like, command button 306 to cause to carry out a display in the display form specified in the command designation column 307, vertical axis setting column 308 to carry out a setting of the vertical axis in the graph and/or to specify a related word type, horizontal axis setting column 309 to carry out a setting of the horizontal axis in the graph or the like, button 310 to return a value in the vertical axis setting column to the default, button 311 to return a value in the horizontal axis setting column to the default, word pattern input column 312 to search for a compound word, button group 313 (on/off/reverse) that is selected when narrowing search is carried out, radio button 314 for a condition (AND/OR) of the narrowing, and display column 315 to display documents extracted by the search.

As shown in FIG. 5, the search keywords input at the step S7 are “software” and “information processing”, the database “patented publication excerpts” is used, and the search is carried out for the whole of the database. In this case, the number of related words in the document group in which the input keywords occur is 1353, and the number of related words in all of the document groups is 29220. Moreover, the number of documents in which the input keywords occur is 60, and the total number of documents is 2752. The words associated with the document group including “software” and “information processing” are displayed in the related word display column 303 in order of the ranking of the degree of relevancy, and the document group including “software” and “information processing” is displayed in the document display column 315 in order of the ranking of the degree of relevancy.

The user specifies the display form of the search result in the command designation column 307 on this screen, and clicks the command button 306. For instance, it is assumed that “table generation” was selected as shown in FIG. 5. The client search interface 33 in the client terminal 3 accepts the command input as to the display form by the user, and transmits a command as to the display form to the search server 5 (step S19). The data operating unit 52 in the search server 5 receives the command as to the display form from the client terminal 3 (step S21), generates display data to achieve the designated display form by using the data extracted at the step S13, and stores it into the work memory area (step S23).

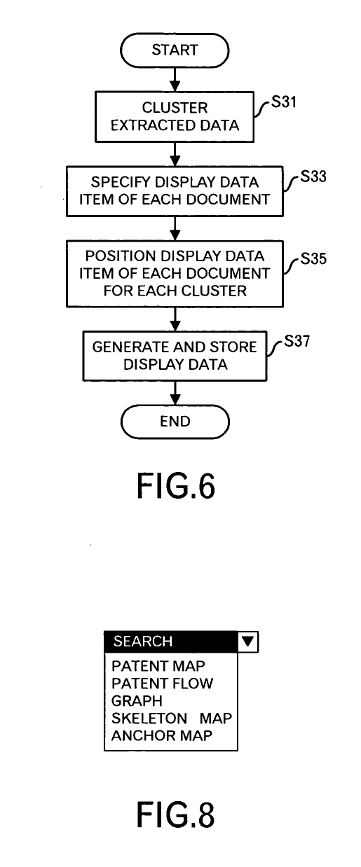

The data operating unit 52 clusters the extracted documents by using the extracted data (here, which includes the abstract, claims, other texts, and bibliographic information in 60 documents) (step S31 in FIG. 6). As for this clustering, the degree of relevancy is calculated for each related word of the extracted documents, and the grouping of words having a high degree of relevancy is carried out. In addition, the degrees of relevancy between the words categorized into each group and each document are calculated, and each document is associated with a group (i.e. cluster) with a high degree of relevancy. Incidentally, as for this clustering calculation, a method is typically known in which each word in the documents is weighted by using “TFIDF” and/or “information amount of Kullback”, then, the document is represented as a vector by using the weights of the words, the degree of relevancy of the document is calculated by the scalar product of the vector, and a clustering algorithm is applied to a relevancy degree matrix obtained by calculating the degrees of relevancy among all of the documents. For instance, as for the details, see the aforementioned patent publications.

In the example of FIG. 5, the following clusters are generated. 1st cluster: form, image, limitation, identification information, goods, delivery, identification 2nd cluster: name, version number, version, reference relation information, reference relation, change, version management 3rd cluster: detachable, information management method, information management, ID, user, software information, user ID 4th cluster: instruction, comparison, address register, execution, address, region, debugging 5th cluster: e-mail, electric, mail, transmission, generation, reception, terminal 6th cluster: version, version upgrade, up, equipment, version information, serial, date The document included in a specific cluster is a document having a high relevancy with the related words included in the specific cluster.

Incidentally, the degree of relevancy of a certain word with a specific document is calculated as follows: (appearance frequency of the certain word or phrase in the specific document)/(the number of documents in which the certain word appears in the database (patented publication group in the above example)) This is defined in a viewpoint in which the word that frequently appears in the specific document is a feature word of the specific document, and on the other hand, the word that appear in a lot of documents can not be said as a feature word in the specific document. However, it is also possible to calculate the degree of relevancy by other methods.

Next, the data operating unit 52 specifies display data item of each document based on the command as to the specified display form (step S33). Here, the publication number, title, and the applicant name are set in advance as the display data items, and such data is specified for each document. Then, the aforementioned display data item for each document is arranged for each cluster (step S35). Incidentally, in this embodiment, the vertical axis represents the cluster and the horizontal axis represents the applicant. That is, each document is classified by a set of the cluster and applicant. However, it is also possible to use another data as to the horizontal axis. Finally, it generates display data in a data format which a specific display processor 34 in the client terminal 3 can process, and stores it into the work memory area (step S37). The specific display processor 34 is selected so as to correspond to the command “table generation”.

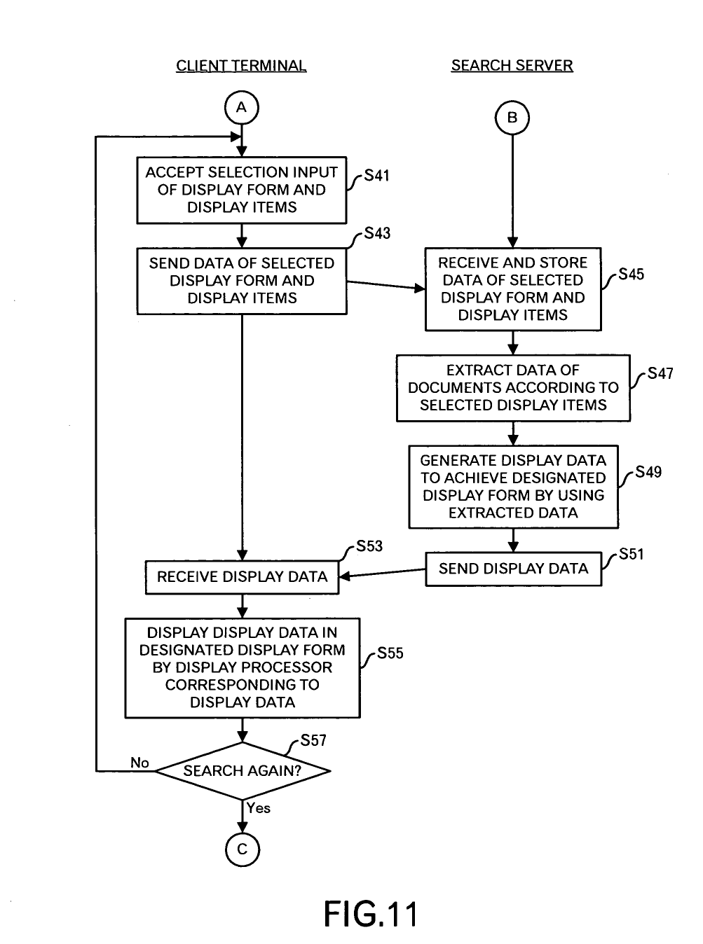

The data operating unit 52 carries out the aforementioned processing, and transmits the generated display data to the client terminal 3 (step S25 in FIG. 2). The client search interface 33 of the client terminal 3 receives the display data from the search server 5 (step S27). Then, the client search interface 33 confirms whether the display processor 34 corresponding to the received display data is activated, and the display processor 34 corresponding to the received display data is activated if it has not been activated. The display processor 34 displays the search result on the display device 31 by using the received display data in the display form designated by the user (step S29). Incidentally, the processing shifts to FIG. 11 through terminals A and B.

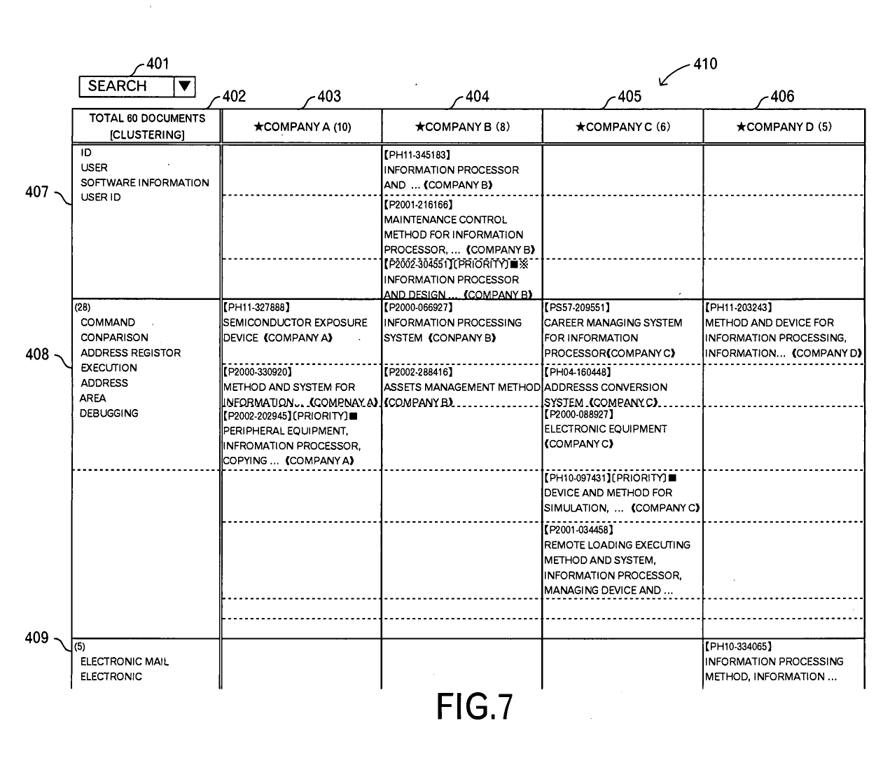

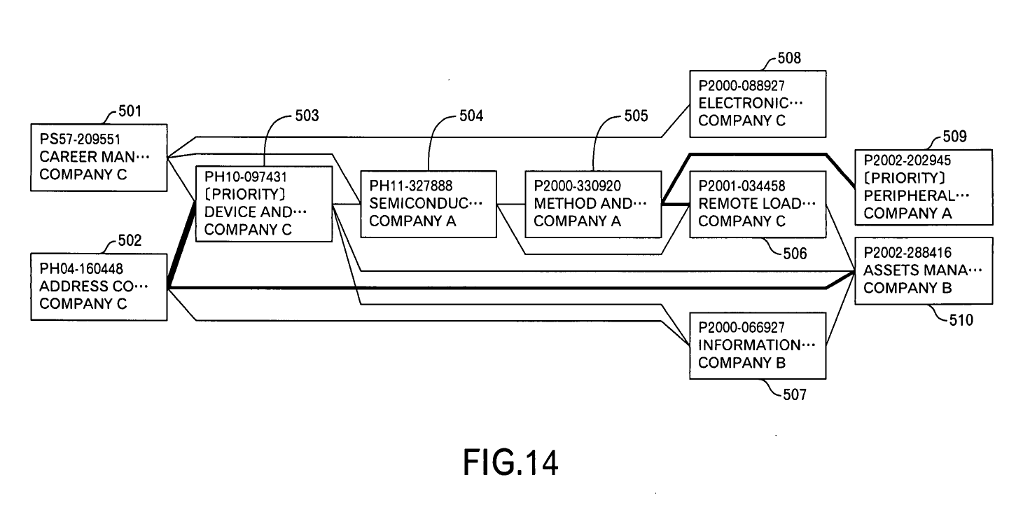

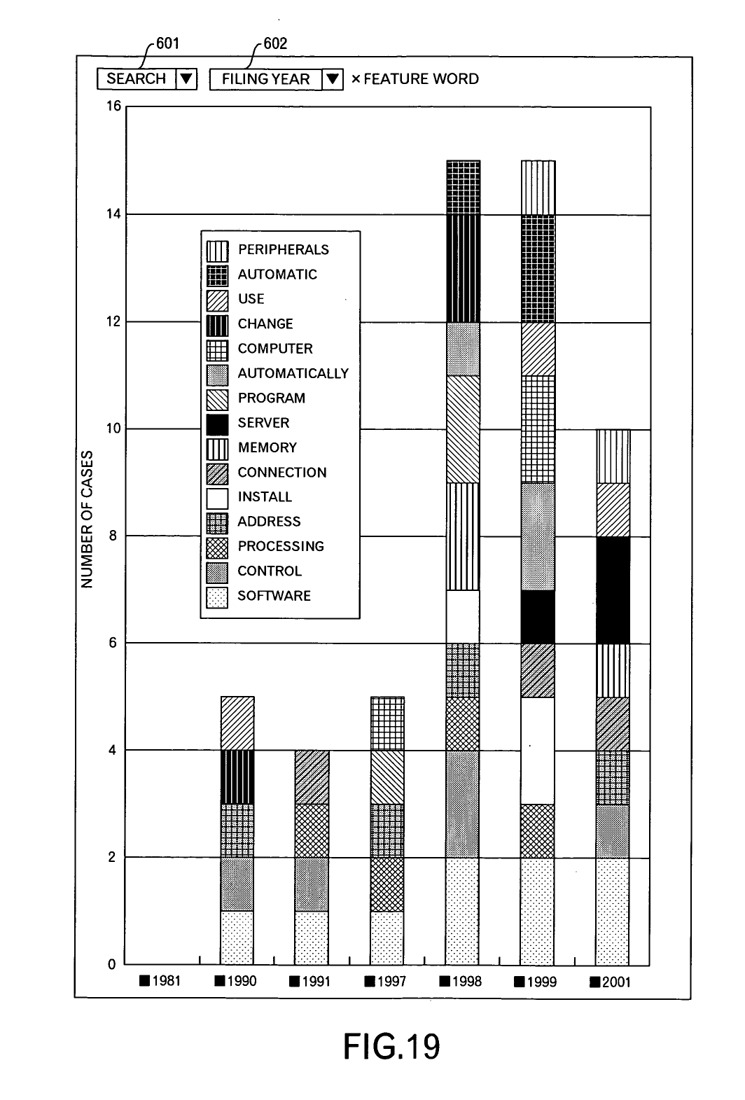

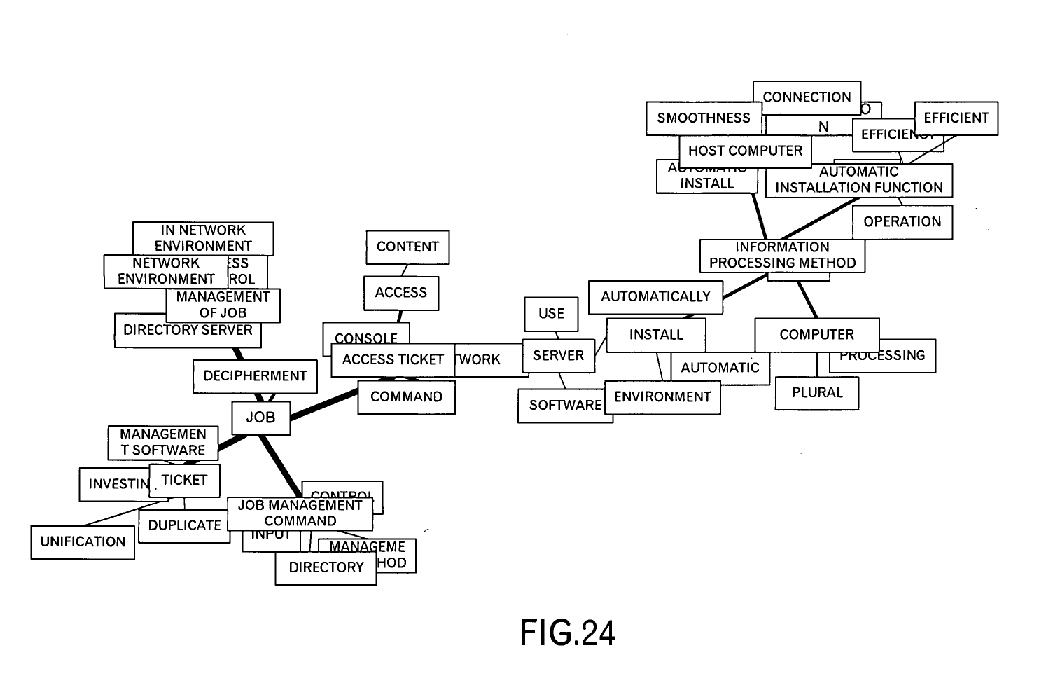

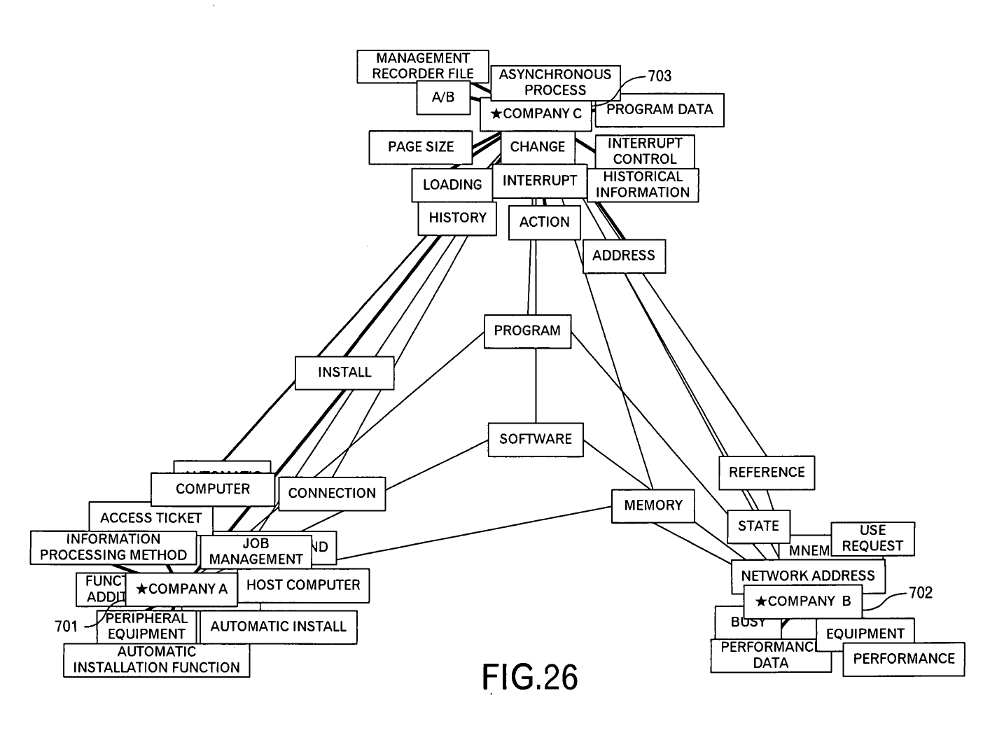

A screen example is shown in FIG. 7. The example of FIG. 7 includes a display form selection column 401 and table 410. The display form selection column 401 is a combo box to select the following display form. For instance, either the patent map (FIG. 7), patent flow (FIG. 14), graph (FIG. 19), skeleton map (FIG. 24) or anchor map (FIG. 26) can be selected as shown in FIG. 8. The table 410 includes a cluster column 402 to display data of each cluster, column 403 to display pertinent documents (10 documents) of company A to each cluster, column 404 to display pertinent documents (8 documents) of company B to each cluster, column 405 to display pertinent documents (6 documents) of company C to each cluster, and column 406 to display pertinent documents (5 documents) of company D to each cluster. As described above, the vertical axis is an axis for the applicants. On the other hand, the table 410 includes a row 407 of the 3rd cluster, row 408 of the 4th cluster, and row 409 of the 5th cluster. Incidentally, as for the lines of the 1st and 2nd clusters, though they are not shown because of the lack of the screen space, they can be displayed by operating the scroll bar or the like. Thus, the user can analyze that applications by which applicant are included in which cluster more. Moreover, it can be grasped that which applicant files a lot of applications in the search result.

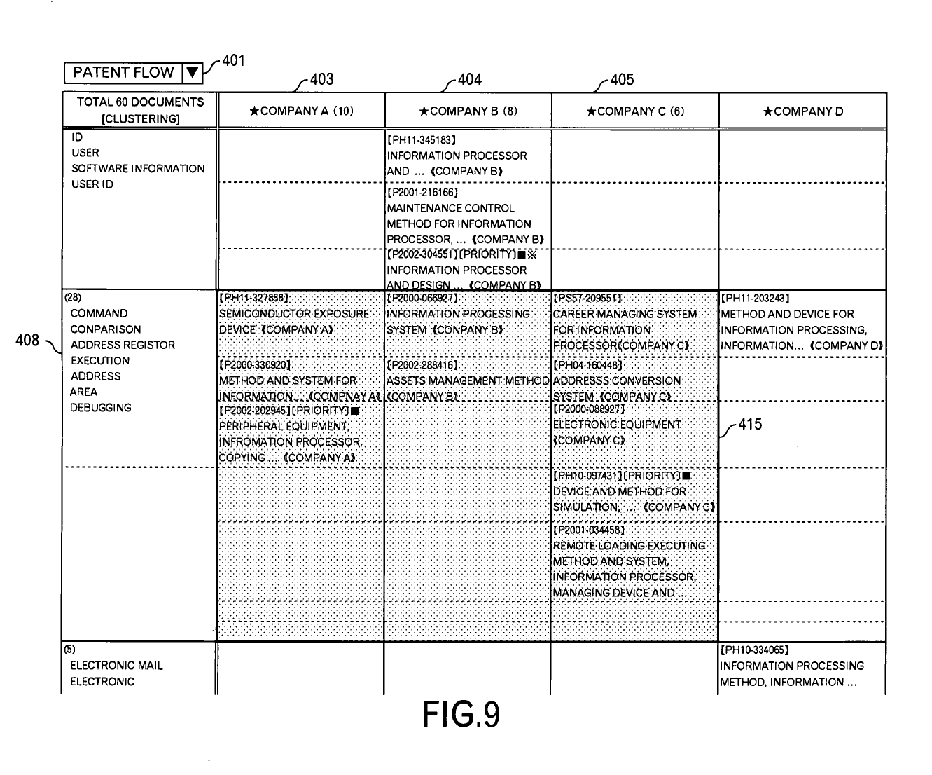

Incidentally, each of the display items including a set of the publication number, title, and applicant name can be selected for the following processing. Moreover, it is also possible to carry out the region designation, and the display items included in the region are selected. For instance, as shown in FIG. 9, 10 display items (documents) included in the row 408 of the 4th cluster and the column 403 of the company A, column 404 of the company B, and column 405 of the company C can be selected by designating a region 415. Incidentally, it is possible to select the display item (document) one by one. It is possible to adopt a display form in which each display item is a button, for instance, and can be clicked.

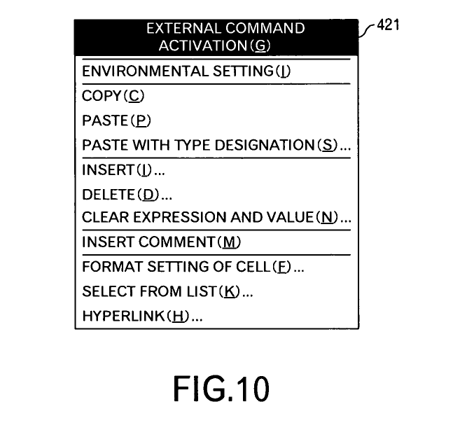

In the example of FIG. 9, it is assumed that the display items (documents) included in the region 415 were selected, and “patent flow” was selected as the following display form in the display form selection column 401. Then, when the user pushes a right button of the mouse that is the input device 32, a menu shown in FIG. 10 is displayed. The example of FIG. 10 includes the following menu items: “activate external command” 421, environmental setting, copy, paste, paste with type designation, insert, delete, clear numerical expression and value, insert comment, format setting of cell, select from list, and hyperlink. Here, the “activate external command” 421 is selected. Incidentally, in this embodiment, it is considered that all display items are tacitly selected, if any display item is not selected.

Then, the display processor 34 accepts the selection input of the display form and display items from the user (step S41 in FIG. 11), and outputs data concerning the selected display items and display form to the client search interface 33 of the client terminal 3.

The client search interface 33 transmits the data concerning the selected display items and display form to the search server 5 (step S43). The data operating unit 52 of the search server 5 receives the data concerning the selected display items and display form, and temporarily stores it into the work memory area (step S45). Then, it extracts the data of the documents corresponding to the selected display items from the document DB 53, for instance (step S47). When the previous processing result has still been held in the work memory area, it is also possible to use the data. Here, because the display item includes at least the publication number, the data of ten documents can be specified from the publication number. Then, it generates display data to achieve the specified display form (here, “patent flow”) by using the extracted data, and stores the display data in the work memory area (step S49).

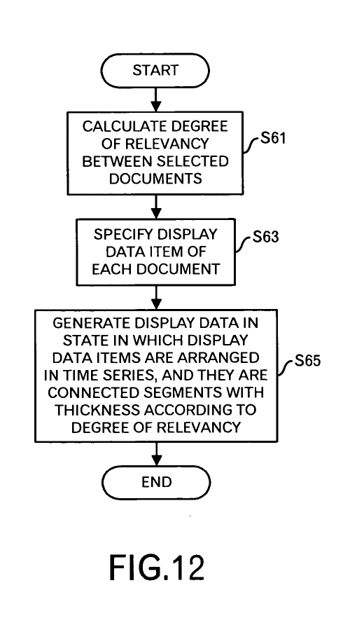

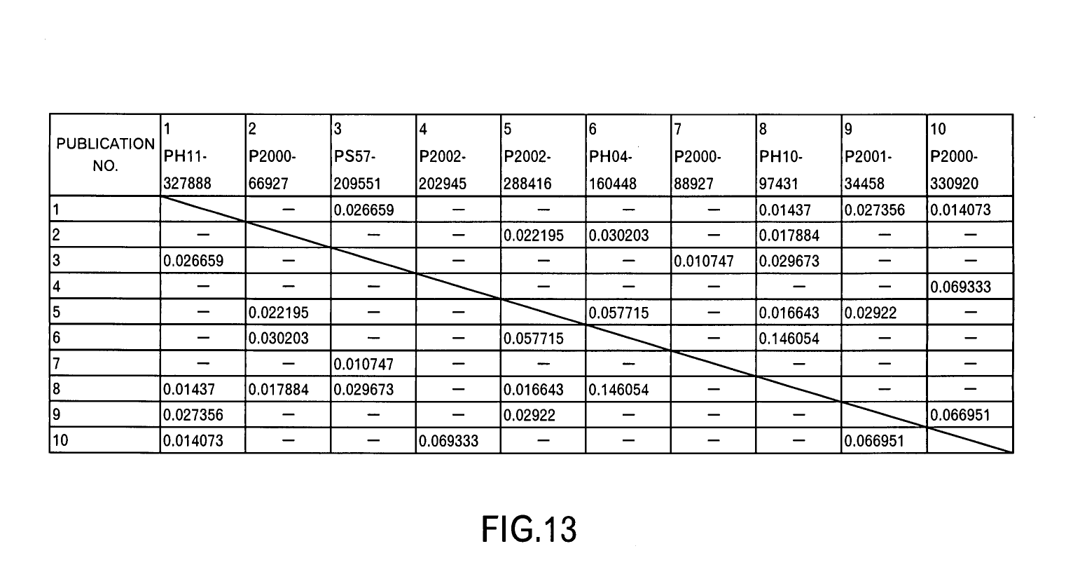

The data operating unit 52 calculates the degree of relevancy between the selected documents by using the data of the documents corresponding to the selected display items (step S61 in FIG. 12). Because the calculation of the degree of relevancy between the selected documents is also well-known technology, it is not explained here. Incidentally, for instance, data as shown in FIG. 13 is generated and is stored into, for instance, the relevancy degree data storage 54. In an example of FIG. 13, 10 selected documents are arranged vertically and horizontally in the same manner, and the degrees of relevancy with the other 9 documents are registered to one document. However, for example, “−” is indicated in a case where the degree of relevancy is equal to or lower than a predefined threshold.

Then, it specifies display data items from the data of each document (step S63). Here, the publication number, title, and applicant are set in advance as the display data items, and such data is specified for each document. Moreover, it generates display data in a state where display items including the display data items are arranged in the time series according to the filing date or the publication date included in the data of the documents, and the display items are connected by segments with the thickness according to the degree of relevancy in a format which the display processor 34 for the patent flow display can process (step S65).

Then, the search server 5 transmits the generated display data to the client terminal 3 (step S51 in FIG. 11). The client search interface 33 of the client terminal 3 receives the display data from the search server 5 (step S53). Then, it confirms whether the display processor 34 corresponding to the received display data has been activated. The display processor 34 is activated if it has not been activated. Then, it outputs the display data to the display processor 34. The display processor 34 corresponding to the display data displays the display data on the display device 31 in the display form designated by the user (step S55). Incidentally, when another searching is carried out, the processing shifts to FIG. 2 through a terminal C. On the other hand, the processing returns to the step S41 when the display form and the display items are selected to progress the analysis as explained below (step S57).

For instance, a screen as shown in FIG. 14 is displayed. In an example of FIG. 14, 10 display items 501 to 510 are arranged from the left to the right in the time series according to the publication date or filing date. Moreover, a segment connects between the display items that have the degree of relevancy equal to or more than a predetermined threshold, and the segment between this display items corresponding to the documents with a higher degree of relevancy is shown thicker. For instance, because the display item 502 and display item 503 have the highest degree of relevancy in the 10 display items, they are connected by the thickest segment. Moreover, the display item 502 and display item 510, the display item 505 and display item 506, and the display item 505 and display item 509 also have a comparatively high degree of relevancy, and they are respectively connected by a medium thick line. Incidentally, all of these display items are selectable, and they may be buttons. Moreover, one or plural display items may be selected by specifying a region.

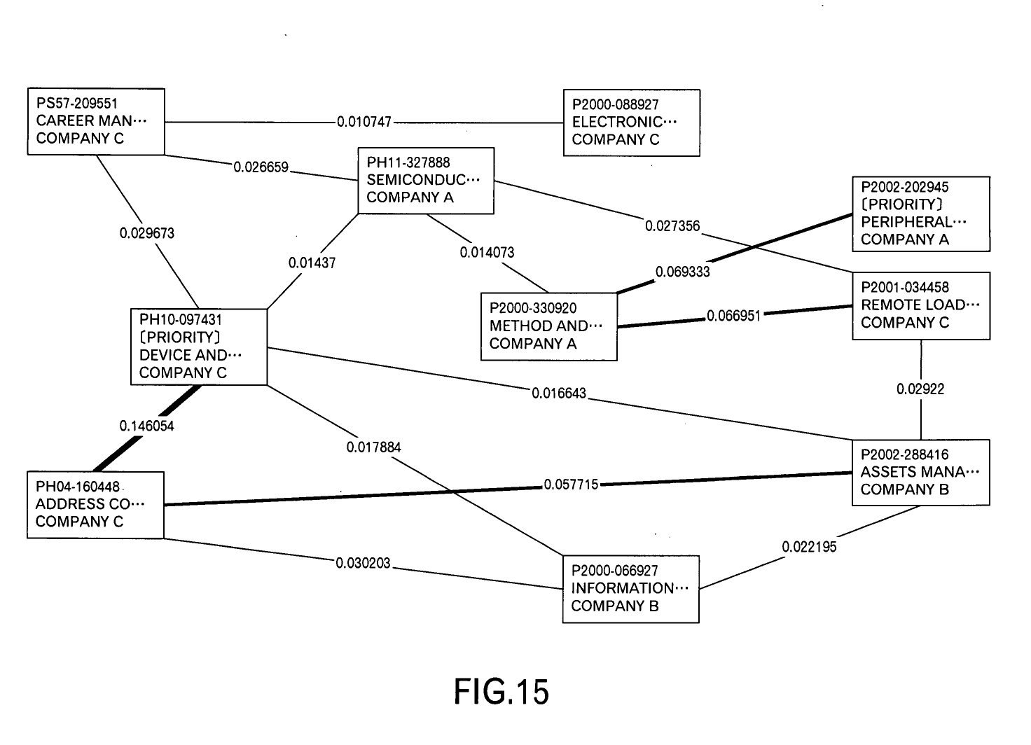

Moreover, not only data concerning the connection relation between the display items and thickness but also the actual degree of relevancy can be held to the segment that connects between the display items. In this case, for instance, the display as shown in FIG. 15 may be carried out by providing a display switch button in addition to, for instance, the display portion in FIG. 14, and clicking the display switch button. In FIG. 15, the degree of relevancy is displayed near the connection line between the display items being displayed. The display item is spaced with other display items to display the numerical value of the degree of relevancy near the connection line. In the screen like FIG. 15, each display item is selectable, and one or plural display items can be selected.

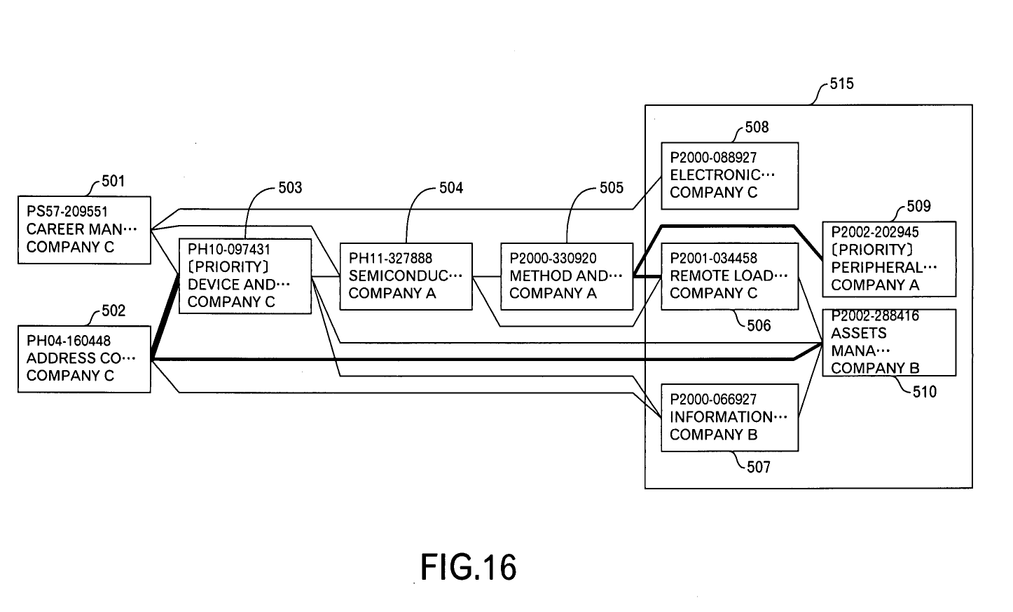

For instance, as shown in FIG. 16, it is assumed that the user specified a region 515 so as to include the display items 506 to 510, “patent flow” was selected again in the display item designation column (for instance, FIG. 7) provided outside the displayed portion in FIG. 16. Then, it is assumed that the menu like FIG. 10, for instance, is further displayed by pushing the right button of the mouse, which is the input device 32, and “activate external command” 421 is selected.

Thus, the display processor 34 of the client terminal 3 accepts the selection input concerning the display form and display items from the user (step S41 in FIG. 11), and outputs the data concerning the selected display form and display items to the client search interface 33. The client search interface 33 receives the data concerning the selected display form and display items, and transmits it to the search server 5 (step S43).

The data operating unit 52 of the search server 5 receives the data concerning the selected display items and display form, and temporarily stores it into the work memory area (step S45). Then, it extracts the data of the documents corresponding to the selected display items from the document DB 53, for instance (step S47). If the previous processing result has still been held in the work memory area, it is also possible to use the data. Here, because the display item includes at least the publication number, the data of 5 documents can be specified from the publication number. Then, it generates display data to achieve the designated display form (here, “patent flow”) by using the extracted data, and stores it in the work memory area (step S49). That is, the processing shown in FIG. 12 will be executed for the data of the 5 documents.

Then, the search server 5 transmits the generated display data to the client terminal 3 (step S51). The client search interface 33 of the client terminal 3 receives the display data from the search server 5 (step S53). Then, it confirms whether the display processor 34 corresponding to the received display data has been activated. The display processor 34 is activated if it has not been activated, yet. Then, it outputs the display data to the display processor 34. The display processor 34 corresponding to the display data displays the display data on the display device 31 in the display form designated by the user (step S55).

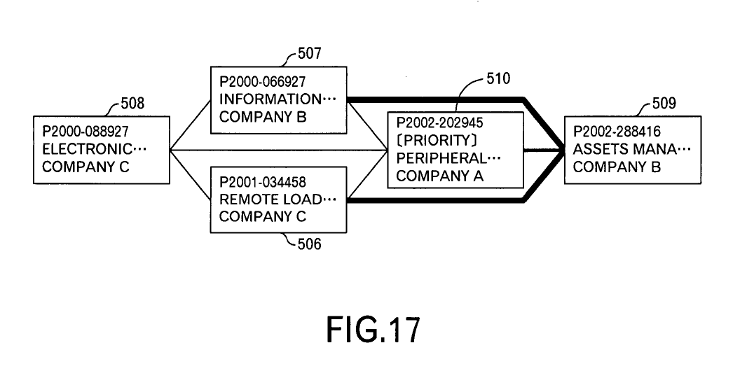

For instance, the screen shown in FIG. 17 is displayed. In FIG. 17, 5 display items are arranged in the time series according to the publication date or filing date. Each display item is selectable, and the segment with the thickness according to the degree of relevancy connects between the documents corresponding to the display items. However, the connection relation in the region 515 of FIG. 16 and the connection relation in FIG. 17 are apparently different. This is because there is a difference between the degree of relevancy among 5 documents and the degree of relevancy among 10 documents. Thus, because the region 515 is not merely enlarged and displayed, but the degree of relevancy is re-calculated among the selected documents in this embodiment, it becomes possible to show the relationship among only the selected documents. In FIG. 17, it is also possible to specify the display items and display form to progress the analysis. Moreover, when any display items are not specified, it is assumed that all of the display items are selected to carry out the processing.

Moreover, it is assumed that “graph” was selected in the display form designation column (for instance, FIG. 7) provided outside the display portion of FIG. 15 without selecting any display items, for instance, in the state shown in FIG. 15. In addition, it is also assumed that the menu like FIG. 10, for instance, was displayed in response to the push of the right button of the mouse, which is the input device 32, and “activate external command” 421 was selected. As described above, it is assumed that all of the display items were selected when any display item was not selected.

Thus, the display processor 34 of the client terminal 3 accepts the selection input concerning the display form and display items from the user (here, the display items were selected indirectly) (step S41 in FIG. 11), and outputs the data concerning the selected display form and display items to the client search interface 33. The client search interface 33 receives the data concerning the selected display form and display items, and transmits it to the search server 5 (step S43).

The data operating unit 52 of the search server 5 receives the data concerning the selected display items and display form, and temporarily stores it into the work memory area (step S45). Then, it extracts the data of the documents corresponding to the selected display items from the document DB 53, for instance (step S47). In a case where the previous processing result has still been held in the work memory area, it is also possible to use the data. Here, because the display item includes at least the publication number, the data of 10 documents can be specified from the publication number. Then, it generates display data to achieve the designated display form (here, “graph”) by using the extracted data, and stores it into the work memory area (step S49).

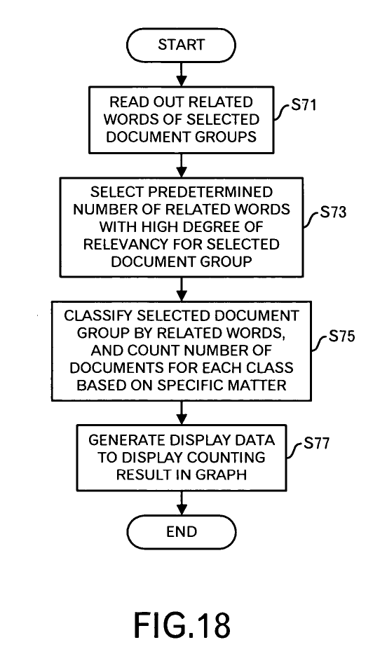

The data operating unit 52 reads out the data of related words of the documents (Hereafter, it is also called “selected documents”) corresponding to the selected display items from the related word data storage 55 (step S71 in FIG. 18). Then, it selects a predetermined number of related words with a high degree of relevancy with the selected document group (step S73). Because it is well-known technology as for the calculation of the degree of relevancy between the documents and words, the detailed explanation is omitted, here. Then, it classifies the selected documents according to the related words, aggregates the number of documents in each class based on a specific issue (here, filing year), and stores the result data into the work memory area, for example (step S75). Here, as to each filing year, it counts up the number of documents including the related word for each related word. Then, it generates display data to display the aggregation result in the graph is with a format that the display processor 34 for the graph display can process, and stores it into the work memory area, for instance (step S77).

Then, the search server 5 transmits the generated display data to the client terminal 3 (step S51 in FIG. 11). The client search interface 33 of the client terminal 3 receives the display data from the search server 5 (step S53). Then, it confirms whether the display processor 34 corresponding to the received display data has already been activated. The display processor 34 is activated if it has not been activated, yet. Then, it outputs the display data to the display processor 34. The display processor 34 corresponding to the display data displays the display data on the display device 31 in the display form designated by the user (step S55).

For instance, a screen as shown in FIG. 19 is displayed. The screen example of FIG. 19 includes a display form designation column 601 and selection column 602 to select the filing year or the applicant, and the vertical axis represents the number of cases (the number of documents), and the horizontal axis represents the filing year. In this example, 15 related words are displayed as display items, and one or plural related words are selectable. That is, words or phrases such as “peripherals” and “automatic operation” are selected regardless of the filing year.

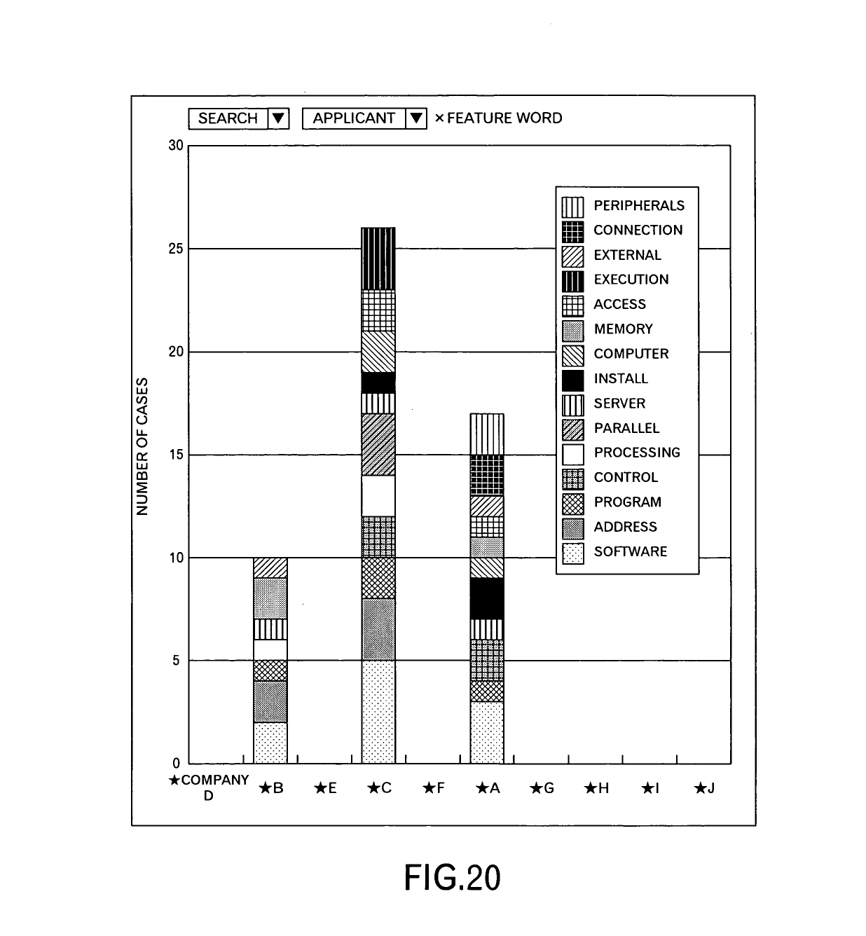

Moreover, the display can be changed to a graph as shown in FIG. 20 by changing the choice in the selection column 602 from “filing year” to “applicant”. In the example of FIG. 20, there is no change as to the related words that are the display items. However, because the horizontal axis is changed from “filing year” to “applicant”, the number of documents including each related word is aggregated for each applicant to display it. Even in FIG. 20, one or plural related words that are the display items are selectable.

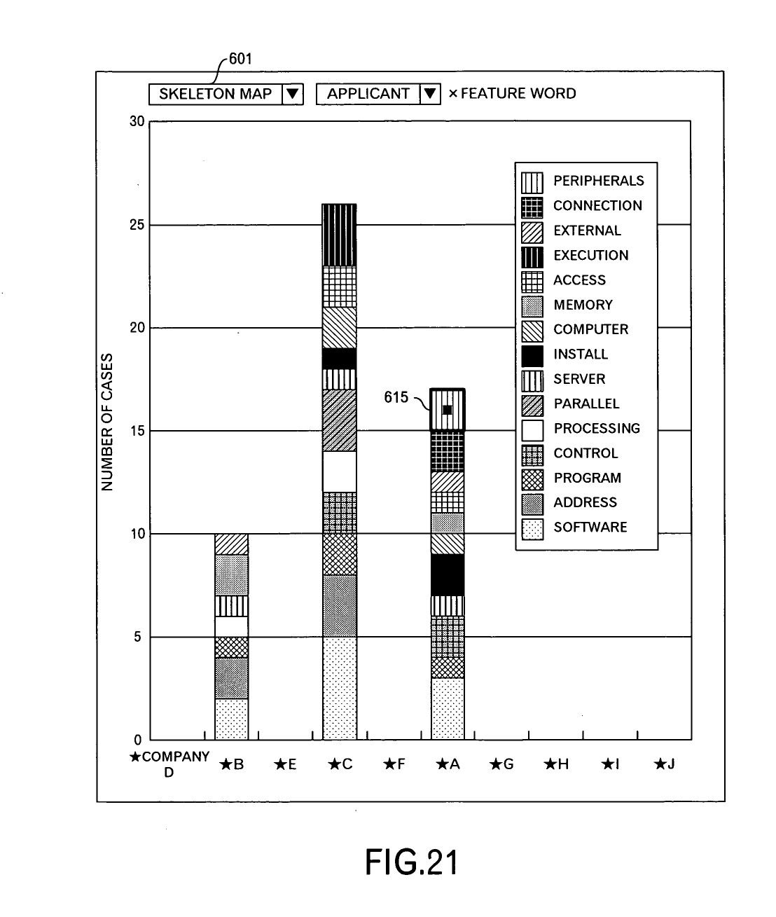

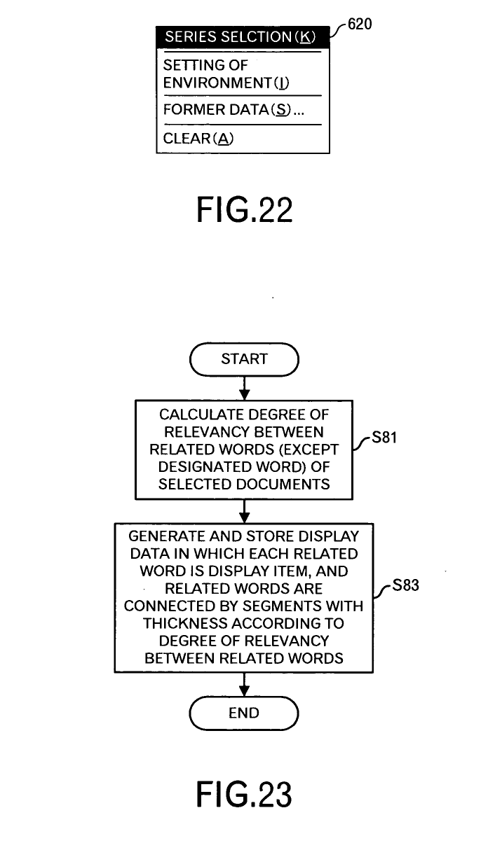

For example, in the graph whose horizontal axis is set to the filing year, it is assumed that “skeleton map” in the display form designation column 601 as shown in FIG. 21 was selected, and “peripherals” 615 of the related word that is the display items was further selected. In FIG. 21, the thick line or the like indicates that the item has been selected. In addition, when the right button of the mouse that is the input device 32 is pushed, a menu as shown in FIG. 22 is displayed. In the menu of FIG. 22, choices “series selection” 620 and “setting of environment”, “former data”, and “clear” are provided. It is assumed that the series selection 620 was selected, here.

Thus, the display processor 34 of the client terminal 3 accepts the selection input concerning the display form and display items from the user (step S41 in FIG. 11), and outputs the data concerning the selected display form and display items to the client search interface 33. The client search interface 33 receives the data concerning the selected display form and display items, and transmits it to the search server 5 (step S43).

The data operating unit 52 of the search server 5 receives the data concerning the selected display items and display form, and temporarily stores it into the work memory area (step S45). Then, it extracts data of the documents corresponding to the selected display items from the document DB 53, for instance (step S47). In a case where the previous processing result has still been held in the work memory area, it is also possible to use the data. For instance, because the display item is “peripherals” here, it specifies the documents, to which “peripherals” is registered as a related word, based on the data stored in the related word data storage 55 by the publication number. Then, it extracts data of the documents from the publication numbers. It generates display data to achieve the designated display form (here, “skeleton map”) by using the extracted data, and stores it into the work memory area (step S49).

The data operating unit 52 calculates the degree of relevancy between words for each related word (words other than “peripherals”, here) that is the data of the extracted document, and stores it into the work memory area, for instance (step S81 in FIG. 23). Incidentally, in a case where the degree of relevancy is equal to or lower than a predetermined reference, the degree of relevancy is regarded as 0. It is also possible to store this data in the relevancy degree data storage 54. Then, it generates display data in the display form in which each word is treated as a display item and the segment between words has the thickness according to the degree of relevancy between the words, in a format which the display processor 34, which displays data in the skeleton map, can process, and stores it into the work memory area, for instance (step S83).

Then, the search server 5 transmits the generated display data to the client terminal 3 (step S51 in FIG. 11). The client search interface 33 of the client terminal 3 receives the display data from the search server 5 (step S53). Then, it confirms whether the display processor 34 corresponding to the received display data has been activated. The display processor 34 is activated if it has not been activated, yet. Then, it outputs the display data to the display processor 34. The display processor 34 corresponding to the display data displays the display data on the display device 31 in the display form designated by the user (step S55).

For instance, a screen as shown in FIG. 24 is displayed. In FIG. 24, each related word is a display item, and it is possible to select one or plural display items. Moreover, in this embodiment, it is judged that all of the display items are selected when any display items are not selected. In addition, by specifying a region, it is also possible to specify the display items (related words) included in the region. In the example of FIG. 24, the related words connected via the thick segment are deeply related, and the degree of relevancy lowers when the thickness of the segment becomes thin from a medium thick line toward a thin line. Incidentally, as for the words not connected, it represents that the degrees of relevancy is equal to or lower than a predetermined reference.

Though it is not show in FIG. 24, the display form designation column to shift from this skeleton map to the following display form is provided. Therefore, after the user selects the following display form in the display form designation column, and further selects display items, the menu screen as shown in FIG. 10, for instance, is displayed, when he or she pushes the right button of the mouse that is the input device 32. When “activate external command” is selected here, the selection input concerning the display form and display items are carried out. Here, it is assumed that all of the display items were selected, and “anchor map” was selected as a display form, for instance.

Thus the display processor 34 of the client terminal 3 accepts the selection input concerning the display form and display items from the user (here, the selection of the display item is indirect) (step S41 in FIG. 11), and outputs the data concerning the selected display form and display items to the client search interface 33. The client search interface 33 receives the data concerning the selected display form and display items, and transmits it to the search server 5 (step S43)

The data operating unit 52 of the search server 5 receives the data concerning the selected display items and display form, and temporarily stores it into the work memory area (step S45). Then, it extracts the data of the documents corresponding to the selected display items from the document DB 53, for instance (step S47). In a case where the previous processing result has still been held, it is also possible to use the data. Because all of the related words except “peripherals” were selected, it specifies the documents, to which either of all of the related words displayed in FIG. 23 is registered as a related word, based on the data stored in the related word data storage 55, by the publication number, for instance. Then, it extracts the data of the documents from the publication numbers. Incidentally, it is also possible to carry out a processing based on the data of the documents extracted by the last processing, assuming that there is no change in the documents to be processed, in a case where all of the related words are selected in FIG. 24. Then, it generates display data to achieve the designated display form (here, “anchor map”) by using the extracted data, and stores it into the work memory area (step S49).

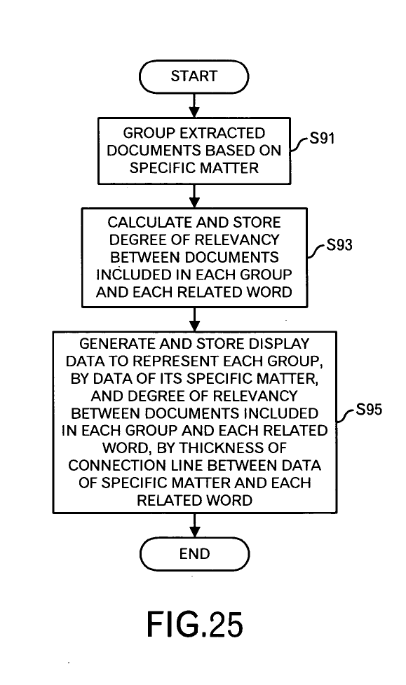

The data operating unit 52 groups the extracted documents based on a specific matter (here, applicant name) (step S91 in FIG. 25). That is, the documents are categorized by each applicant. Next, it calculates the degrees of relevancy between documents included in each group and each related word, and stores them into the work memory area, for instance (step S93). Moreover, it is also possible to store them in the relevancy degree data storage 54. Then, it generates display data in which each group (here, “company A”, “company B”, and “company C”) is represented by the data of the specific matter (applicant name), and the degrees of relevancy between the documents included in each group and each related word are represented by the thickness of the segments between the data of the specific matter for the group and the related words in a format which the corresponding display processor 34 can process, and stores it into the work memory area, for instance (step S95).

Then, the search server 5 transmits the generated display data to the client terminal 3 (step S51 in FIG. 11). The client search interface 33 of the client terminal 3 receives the display data from the search server 5 (step S53). Then, it confirms whether the display processor 34 corresponding to the received display data has been activated. The display processor 34 is activated if it has not been activated, yet. Then, it outputs the display data to the display processor 34. The display processor 34 corresponding to the display data displays the display data on the display device 31 in the display form designated by the user (step S55).

For instance, a screen shown in FIG. 26 is displayed. In FIG. 26, selectable display items are “company A” 701, “company B” 702, and “company C” 703 that are the applicant name, and all of the related words. However, because any related word whose degree of relevancy is equal to or lower than a predetermined threshold, is not connected with any applicant name, the display is omitted. These display items may be buttons to make it selectable. Moreover, it is also possible to separately provide any button or the like to indicate the selection. Moreover, it is possible to designate a region to select any display items included in the region. In FIG., 26, the positions of the applicant names “company A” 701, “company B” 702, and “company C” 703 are fixed, the segments with the thickness representing the degree of relevancy with the related word radically extend from these applicant names to the related words. Because there is a related word associated with plural document sets, the related word is connected with plural applicant names by plural segments.

Though it is not shown in FIG. 26, it is also possible to provide the display form designation column to designate the following display form on FIG. 26. That is, it is possible to designate plural display items and display form to cause them to be displayed in the following display form.

As described above, by the direct transition from a certain display form to another display form, such as a graph, table, various kinds of flows, or the like, the analyst can investigate and analyze data without terminating his or her consideration on the way of his or her analysis. Moreover, because the meanings of the aforementioned display forms that respectively represent the classification based on the degree of relevancy, transition based on a specific matter of the document content, or degree of relevancy along the time series, are different each other, this embodiment supports the analyst to progress the investigation and analysis in various viewpoints.

In addition, because a range to be analyzed can be specified when shifting to another display form, it is possible to carry out associative investigation and analysis. Moreover, because when the range that the analyst wants to analyze is specified, the degree of relevancy or the like is newly calculated according to the documents within the range to display the results, the analyst's consideration can be supported by the newly displayed classification with higher accuracy.

Though an embodiment of this invention was explained above, this invention is not limited to the aforementioned embodiment. For instance, though an example of the display form transition was explained using figures, it is not necessary to take such a route, and it is possible to select an arbitrary display form at any stage. The shiftable display form may be limited by some reasons. However, it is possible to fundamentally shift to an arbitrary display form.

Moreover, the functional blocks shown in FIG. 1 are mere examples, and they do not necessarily correspond to actual program modules. Moreover, though only one implementation example in the client-server environment was explained, it is also possible to carry out the aforementioned processing by only a terminal apparatus with the functions of the search server 5 and the client terminal 3. Only the search function may be provided on the server.

Moreover, the display examples are mere examples, therefore, it is not necessary to configure the aforementioned screen.

In addition, the calculation method of the degree of relevancy is arbitrary, and as for the display forms, they are not limited to the aforementioned ones. It is also possible to process the data of the documents by other processing algorithm to present it to the user.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A search processing method, comprising:
searching a predetermined document group according to a search condition specified by a user to extract data of a plurality of documents;
transforming said data of said plurality of documents into data to indicate said data of said plurality of documents to said user in a first display form and to enable said user to select each display item as a following processing key, and outputting the transformed data;
extracting data of documents corresponding to said display items directly or indirectly selected by said user; and
transforming said data of said documents corresponding to said selected display items into data to indicate said data of said documents to said user in a second display form specified by said user and to enable said user to select each display item specified based on said data of said documents as a following processing key, and outputting the transformed data.

2. The search processing method as set forth in claim 1, wherein each said first and second display forms is at least either of
a form showing indications of extracted documents that have been classified by used words, each said indication including a predefined display matter of said document,
a form showing indications of said extracted documents, and segments between the indications, each said indication including a predefined display matter, and each said segment representing a degree of relevancy between said extracted documents, that is calculated by used words,
a form showing a graph representing a result obtained by classifying and aggregating said extracted documents based on used words;
a form showing used words in said extracted documents and connection lines representing a degree of relevancy among said used words, and
a form showing first indications of document groups, second indications of used words, and connection lines between said first indication and said second indication, each said first indication including a specific matter, said document group being composed of extracted documents associated by said specific matter, and each said connection line representing a degree of relevancy between said document group and said used word.

3. The search processing method as set forth in claim 1, wherein said first transforming comprises:
clustering each said document by using said data of said plurality of documents;
extracting data concerning a display matter predefined for said first display form from said data of said plurality of documents; and
generating data to display the extracted data concerning said display matter as said following processing key for each cluster.

4. The search processing method as set forth in claim 1, wherein said first transforming comprises:
calculating a degree of relevancy between said plurality of documents by using said data of said plurality of documents;
extracting a data item concerning a display matter predefined for said first display form, for each said document, from said data of said plurality of documents; and
generating data to display said data items concerning said display matter, each said data item being extracted for each said document and being said following processing key, and a segment that connects between said data items and represents the calculated degree of relevancy between said documents corresponding to said data items.

5. The search processing method as set forth in claim 1, wherein said first transforming comprises:
classifying said plurality of documents based on used words included in said data of said plurality of documents, and counting a number of documents in each class based on a specific matter predefined for said first display form; and
generate data to display the counting result.

6. The search processing method as set forth in claim 1, wherein said first transforming comprises:
calculating a degree of relevancy between used words included in said data of said plurality of documents; and
generating data to display said used words as said following processing keys, and a segment that connects between said used words and represents the calculated degree of relevancy between said used words.

7. The search processing method as set forth in claim 1, wherein said first transforming comprises:
relating said plurality of documents into document groups based on a specific matter predefined for said first display form;
calculating a degree of relevancy between said document group and each used word included in said data of said plurality of documents; and
generating data to display said document group as said following processing key, by data of said specific matter, and the calculated degree of relevancy between said document group and said used word, by a segment connecting between said document group and said used word.

8. The search processing method as set forth in claim 1, wherein said second transforming comprises:
clustering each said document by using said data of said documents specified from said selected display items;
extracting data concerning a display matter predefined for said second display form from said data of the specified documents; and
generating data to display the extracted data concerning said display matter as said following processing key for each cluster.

9. The search processing method as set forth in claim 1, wherein said second transforming comprises:
calculating a degree of relevancy between said documents by using said data of said documents specified from said selected display items;
extracting a data item concerning a display matter predefined for said second display form, for each said specified document, from said data of the specified documents; and
generating data to display said data items concerning said display matter, each said data item being extracted for each said specified document and being said following processing key, and a segment that connects between said data items and represents the calculated degree of relevancy between said specified documents.

10. The search processing method as set forth in claim 1, wherein said second transforming comprises:
classifying said documents specified from said selected display items based on used words included in said data of the specified documents, and counting a number of documents in each class based on a specific matter predefined for said second display form; and
generate data to display the counting result.

11. The search processing method as set forth in claim 1, wherein said second transforming comprises:
calculating a degree of relevancy between used words included in said data of said documents specified from the selected display items; and
generating data to display said used words as said following processing keys, and a segment that connects between said used words and represents the calculated degree of relevancy between said used words.

12. The search processing method as set forth in claim 1, wherein said second transforming comprises:
categorizing said documents specified from the selected display items into document groups based on a specific matter predefined for said first display form;
calculating a degree of relevancy between said document group and each used word included in said data of the specified documents; and
generating data to display said document group as said following processing key, by data of said specific matter, and the calculated degree of relevancy between said document group and said used word, by a segment connecting between said document group and said used word.

13. The search processing method as set forth in claim 1, wherein said document is a patent document, and said display item is either of bibliographic information of said patent document and a used word in said patent document.

14. The search processing method as set forth in claim 1, wherein at least either of said first and second transformings comprises specifying a display program corresponding to a display form, and generating data for said display program.

15. The search processing method as set forth in claim 1, wherein at least either of said first and second display forms is an arbitrary combination of predefined display forms.

16. A program embodied on a medium, for causing a computer to execute a search processing, said program comprising:
searching a predetermined document group according to a search condition specified by a user to extract data of a plurality of documents;
transforming said data of said plurality of documents into data to indicate said data of said plurality of documents to said user in a first display form and to enable said user to select each display item as a following processing key, and outputting the transformed data;
extracting data of documents corresponding to said display items directly or indirectly selected by said user; and
transforming said data of said documents corresponding to said selected display items into data to indicate said data of said documents to said user in a second display form specified by said user and to enable said user to select each display item specified based on said data of said documents as a following processing key, and outputting the transformed data.

17. The program as set forth in claim 16, wherein each said first and second display forms is at least either of
a form showing indications of extracted documents that have been classified by used words, each said indication including a predefined display matter of said document,
a form showing indications of said extracted documents, and segments between the indications, each said indication including a predefined display matter, and each said segment representing a degree of relevancy between said extracted documents, that is calculated by used words,
a form showing a graph representing a result obtained by classifying and aggregating said extracted documents based on used words;
a form showing used words in said extracted documents and connection lines representing a degree of relevancy among said used words, and
a form showing first indications of document groups, second indications of used words, and connection lines between said first indication and said second indication, each said first indication including a specific matter, said document group being composed of extracted documents associated by said specific matter, and each said connection line representing a degree of relevancy between said document group and said used word.

18. A search processing apparatus, comprising:
a search unit to search a predetermined document group according to a search condition specified by a user to extract data of a plurality of documents;
a first transformer to transform said data of said plurality of documents into data to indicate said data of said plurality of documents to said user in a first display form and to enable said user to select each display item as a following processing key, and outputting the transformed data;
an extractor to extract data of documents corresponding to said display items directly or indirectly selected by said user; and
a second transformer to transform said data of said documents corresponding to said selected display items into data to indicate said data of said documents to said user in a second display form specified by said user and to enable said user to select each display item specified based on said data of said documents as a following processing key, and outputting the transformed data.

19. The search processing apparatus as set forth in claim 17, wherein each said first and second display forms is at least either of
a form showing indications of extracted documents that have been classified by used words, each said indication including a predefined display matter of said document,
a form showing indications of said extracted documents, and segments between the indications, each said indication including a predefined display matter, and each said segment representing a degree of relevancy between said extracted documents, that is calculated by used words,
a form showing a graph representing a result obtained by classifying and aggregating said extracted documents based on used words;
a form showing used words in said extracted documents and connection lines representing a degree of relevancy among said used words, and
a form showing first indications of document groups, second indications of used words, and connection lines between said first indication and said second indication, each said first indication including a specific matter, said document group being composed of extracted documents associated by said specific matter, and each said connection line representing a degree of relevancy between said document group and said used word.
